(19) United States
(12) Patent Application Publication
(10) Pub. No.: US 2025/0059460 A1
(43) Pub. Date: Feb. 20, 2025

(54) COATING METHOD OF A COMPOSITE COATING ON A SLIDE, SLIDE AND USE METHOD THEREOF

(71) Applicant: Montrauli Technology Company Limited, Tsuen Wan (HK)

(72) Inventors: Wan Yuen TUNG, Tsuen Wan (HK); Wuxiang LIU, Tsuen Wan (HK)

(21) Appl. No.: 18/658,030

(22) Filed: May 8, 2024

(30) Foreign Application Priority Data
Aug. 15, 2023 (HK) 32023077618.1

(51) Int. Cl. C10M 173/02; A63G 21/00; C10M 103/04; C10M 107/44; C10M 111/04; C10M 155/02; C10M 177/00; C10N 50/00; C10N 50/02; C10N 70/00

(52) U.S. Cl. CPC C10M 173/02; A63G 21/00; C10M 103/04; C10M 107/44; C10M 111/04; C10M 155/02; C10M 177/00; C10M 2201/053; C10M 2217/0453; C10M 2229/02; C10M 2229/047; C10N 2050/02; C10N 2050/023; C10N 2070/00

(57) ABSTRACT

A composite coating includes a water-based two-component polyurethane topcoat and a nano-silicon varnish. The coating method of the composite coating on the slide includes uniformly stirring the water-based two-component polyurethane topcoat, then coating the surface of the slide with the water-based two-component polyurethane topcoat; rolling patterns on the surface of the water-based two-component polyurethane topcoat by using a sponge embossing roller before the surface of the water-based two-component polyurethane topcoat dries; and after rolling is completed, place to dry, and then coat the nano-silicon varnish to form a smooth surface after confirming the surface of the water-based two-component polyurethane topcoat has dried. The sponge embossing roller is used for rolling the patterns before the water-based two-component polyurethane topcoat has not dried, so that the contact area with the nano-silicon varnish is increased, indirectly promoting the adhesion ability of the nano-silicon varnish and ensuring the firmness of the composite coating.

### TECHNICAL FIELD

The present invention relates to the field of slide, particularly to a coating method of a composite coating on a slide, a slide and a use method thereof.

### BACKGROUND ART

As comprehensive activity devices, slides are commonly used in daily recreational venues. To ensure safety, the existing slides are typically designed to have a small height or be in a closed form, but in such design, the surface of the slide often has large frictional resistance, the sliding speed is limited, failing to achieve an exciting experience, thereby reducing the entertainment value of the slide.

Therefore, it is necessary to invent a slide that can minimize frictional resistance to maximize the entertainment value while ensuring safety.

### SUMMARY OF THE UTILITY MODEL

The first objective of the present invention is to provide a coating method of a composite coating on a slide to solve the problem of large frictional resistance of the existing slides.

The second objective of the present invention is to provide a slide obtained by coating the composite coating using the aforementioned coating method.

The third objective of the present invention is to provide a use method for the aforementioned slide.

In order to achieve the first objective, the present invention provides a method for applying a composite coating on a slide. The composite coating comprises a water-based two-component polyurethane topcoat and a nano-silicon varnish. The coating method of the composite coating on the slide comprises the following steps: S1, uniformly stirring the water-based two-component polyurethane topcoat, then coating the surface of the slide with the water-based two-component polyurethane topcoat; S2, rolling patterns on the surface of the water-based two-component polyurethane topcoat by using a sponge embossing roller before the surface of the water-based two-component polyurethane topcoat dries; and S3, after rolling is completed, place to dry, and then coat the nano-silicon varnish to form a smooth surface after confirming the surface of the water-based two-component polyurethane topcoat has dried.

It can be seen from the above solution that the water-based two-component polyurethane topcoat and the nano-silicon varnish both have good adhesion ability, the water-based two-component polyurethane topcoat can be well fixed to the fiberglass surface layer of the slide, and the step of rolling patterns on the surface of the water-based two-component polyurethane topcoat by using the sponge embossing roller before the surface of the water-based two-component polyurethane topcoat dries increases the contact area with the nano-silicon varnish, indirectly promotes the adhesion ability of the nano-silicon varnish and ensuring the firmness of the composite coating. On the basis of not changing the height and external structure of the slide, the safety of the slide is ensured, and the frictional resistance of the surface of the slide is reduced by adding a smooth nano-silicon varnish, thereby increasing the entertainment value.

As a further solution, in S2, the water-based two-component polyurethane topcoat is rolled at least twice; and in S3, the nano-silicon varnish is coated at least twice.

It can be seen from the above solution that rolling the water-based two-component polyurethane topcoat twice or more can increase the surface area, so that the nano-silicon varnish can be bonded to the surface of the water-based two-component polyurethane topcoat more firmly. Coating the nano-silicon varnish twice or more makes the formed surface more regular and smoother and improves the effect of less frictional resistance.

As a further solution, the coating method in S1 and S3 is roll coating or spray coating.

As a further solution, the coating method in S1 comprises: using a flat coating roller with a bristle length of more than 16 mm to coat the water-based two-component polyurethane topcoat on the surface of the slide after stirring the water-based two-component polyurethane topcoat evenly.

It can be seen from the above solution that roll coating by a flat coating roller is convenient in operation and saves topcoat.

As a further solution, the water-based two-component polyurethane topcoat comprises water-dispersible polyisocyanate and water-based polyurethane paint, and the water-based polyurethane paint comprises water-based polyurethane emulsion, polyether-modified siloxane leveling agent, defoaming agent, thixotropic anti-sagging additive, wetting and leveling agent, wetting agent, PH regulator, preservative, deionized water and thickening agent; the content of NCO in the water-dispersible polyisocyanate is 21.5%; the content of the water-based polyurethane emulsion in the water-based polyurethane paint is 75% to 85%; the solid content of the water-based polyurethane emulsion is 40%, and the hydroxyl content is 2%; the mass ratio between the water-dispersible polyisocyanate and the water-based polyurethane paint is 10:1 to 2:1, preferably 8:1 to 4:1, more preferably 20:3; the nano-silicon varnish comprises polysiloxane resin, polyether-modified siloxane leveling agent, organic silicone defoaming agent and solvent; the content of the polysiloxane resin in the nano-silicon varnish is 60% to 70%; and the solid content of the polysiloxane resin is 40%.

It can be seen from the above solution that the water-based two-component polyurethane topcoat made of the above components has good adhesion, high hardness and good anti-corrosion effect and is safe and environmentally friendly. The nano-silicon varnish made of the above components is composed of a high-branched chain ternary polymer, is reformed into an inorganic surface with hardness ≥4 H, and can form a coating with high hardness on the surface of the object. When the surface of clothes or articles is rubbed against the slide surface, the high-hardness surface will avoid wear or scratching. The inorganic siloxane bond (—Si—O—Si—) in polysiloxane has high thermal stability and will not be decomposed or broken due to chemical reaction of the coating under a high temperature environment or heat generated by friction, thereby providing the formed coating with good abrasion resistance and high hardness, and prolonging the service life of ordinary coating. It is fire resistance, has strong water impact resistance under strong adhesion. It also possesses certain flexibility and is non-toxic and pollution-free. At the same time, the aforementioned water-based two-component polyurethane topcoat and nano-silicon varnish are cheaper than the existing coatings in the market.

As a further solution, the application viscosity of the water-based two-component polyurethane topcoat is greater than 140 KU.

It can be seen from the above solution that the above application viscosity can improve the thixotropy of polyurethane topcoat.

As a further solution, the total application amount of the water-based two-component polyurethane topcoat is 0.1 kg/m²; and the nano-silicon varnish is applied at 0.1 kg/m² per time.

It can be seen from the above solution that at the above application amount, the coating is thin while assuring the use effect, thereby saving coating and cost.

In order to achieve the second objective, the present invention provides a slide obtained by coating the composite coating using the aforementioned coating method.

As a further solution, a lubricant is coated on the composite coating on the surface of the slide, preferably, once a week.

As a further solution, the slide further comprises a nylon pad, the density of the bottom surface of the nylon pad is 18 to 60 mesh, preferably, 18 mesh, 25 mesh or 40 mesh; the nylon pad is placed on the surface of the slide, and a person or an object is located on the nylon pad and slides down from the slide surface together with the nylon pad.

It can be seen from the above solution that the aforementioned slide can be maintained easily, has a good anti-friction effect and increases the entertainment value while ensuring safety.

In order to achieve the third objective, the present invention provides a use method for the aforementioned slide. The use method includes that the slide is used together with a nylon pad, and the person or object is located on the nylon pad and slides down from the slide surface together with the nylon pad; and the density of the bottom surface of the nylon pad is 18 to 60 mesh, preferably, 18 mesh, 25 mesh or 40 mesh.

It can be seen from the above solution that the nylon pad ensures a more stable sliding speed when sliding, the friction coefficient of the nylon pad is 0.35, and can be reduced to 0.1 to 0.15 at a high load condition; with a heat-resistance temperature of 121° C. to 149° C., the nylon pad is suitable for outdoor use; the nylon pad has good wear resistance. The use of the nylon pad for a slide coated with composite coating further avoids the problem of deceleration of people or objects on the slide path and increases the entertainment value.

### BRIEF DESCRIPTION OF THE DRAWINGS

FIG. 1 is a schematic view of the cross section of a coating on the slide surface in the present invention.

FIG. 2 is a schematic view of a slide as a whole in the present invention.

The present invention will be further described in detail below with reference to the accompanying drawings and embodiments.

### DETAILED DESCRIPTION

This embodiment provides a coating method for a composite coating on a slide. The composite coating comprises a water-based two-component polyurethane topcoat and a nano-silicon varnish. The water-based two-component polyurethane topcoat comprises water-dispersible polyisocyanate and water-based polyurethane paint, the water-based polyurethane paint comprises water-based polyurethane emulsion, polyether-modified siloxane leveling agent, defoaming agent, thixotropic anti-sagging additive, wetting and leveling agent, wetting agent, PH regulator, preservative, deionized water and thickening agent, and the mass ratio between the water-dispersible polyisocyanate and the water-based polyurethane paint is 10:1 to 2:1; the nano-silicon varnish comprises polysiloxane resin, polyether-modified siloxane leveling agent, organic silicone defoaming agent and solvent.

The coating method of the composite coating on the slide comprises the following steps: S1, uniformly stirring the water-based two-component polyurethane topcoat and then coating the surface of the slide with the water-based two-component polyurethane topcoat; S2, rolling patterns on the surface of the water-based two-component polyurethane topcoat by using a sponge embossing roller before the surface of the water-based two-component polyurethane topcoat dries; S3, after rolling is completed, place to dry, and then coating the nano-silicon varnish to form a smooth surface after confirming the surface of the water-based two-component polyurethane topcoat has dried. In S2, the water-based two-component polyurethane topcoat is rolled at least twice; and in S3, the nano-silicon varnish being coated at least twice. The application method in S1 and S3 is roll coating or spray coating.

In this embodiment, the content of NCO in the water-dispersible polyisocyanate is 21.5%.

The water-based polyurethane paint comprises 800 parts of water-based polyurethane emulsion, 5 parts of polyether-modified siloxane leveling agent, 5 parts of defoaming agent, 5 parts of thixotropic anti-sagging additive, 5 parts of wetting and leveling agent, 20 parts of dipropylene glycol methyl ether, 40 parts of propylene glycol butyl ether, 3 parts of PH regulator, 2 parts of preservative, 16 parts of thickening agent and 99 parts of deionized water, wherein the solid content of the water-based polyurethane emulsion is 40%, and its hydroxyl content is 2%.

The nano-silicon varnish comprises 100 parts of polysiloxane resin, 1.5 parts of polyether-modified siloxane leveling agent, 1.5 parts of organic silicone defoaming agent and 50 parts of ethylene glycol monobutyl ether, wherein the solid content of the polysiloxane resin is 40%.

In this embodiment, the method for preparing the water-based polyurethane paint comprises the following steps:
S1. Accurately weighing 800 parts of (weight ratio) water-based polyurethane emulsion (solid content 40%, hydroxyl content 2%), and putting it into a clean dispersion cylinder;
S2. Adding 5 parts of polyether-modified siloxane leveling agent, 5 parts of defoaming agent, 5 parts of thixotropic anti-sagging additive and 5 parts of wetting and leveling agent in order in the process of low-speed dispersion;
S3. Dispersing at a high speed for 30 minutes and confirming no shrinkage hole by using a scraping fineness plate;
S4. Evenly mixing 20 parts of dipropylene glycol methyl ether solvent, 40 parts of propylene glycol butyl ether solvent and 70 parts of deionized water, and then slowly adding the above liquid in the process of dispersion;
S5. Adding 3 parts of PH regulator, 2 parts of preservative, 29 parts of deionized water and 16 parts of thickening agent in order in the process of low-speed dispersion;
S6. Dispersing at a low speed for 10 minutes and adjusting viscosity to 105 KU to obtain a water-based polyurethane paint.

In this embodiment, the method for preparing water-based two-component polyurethane topcoat comprises the following steps:

Mixing the water dispersible polyisocyanate and the water-based polyurethane paint at a weight ratio of 20:3 to obtain the water-based two-component polyurethane topcoat.

In this embodiment, the method for preparing the nano-silicon varnish comprises the following steps:
S1. Accurately weighing 100 parts of inorganic-hybrid nano polysiloxane resin (solid content 40%), and putting it into a clean dispersion cylinder;
S2. Adding 1.5 parts of polyether-modified siloxane leveling agent, 1.5 parts of organic silicone defoaming agent and 50 parts of ethylene glycol monobutyl ether solvent in order in the process of low-speed dispersion;
S3. Dispersing at a low speed for 10 minutes to obtain the nano-silicon varnish.

The performance characteristics of the water-based two-component polyurethane topcoat in this embodiment are obtained according to relevant test standards and are shown in Table 1 below:

TABLE 1

| Item | Parameter | | Test method |
|---|---|---|---|
| Color | Medium grey and other colors | | Visual inspection |
| Fineness | ≤30 | um | GB/T 6753.1-2007 |
| Gloss | 70 | | GB/T 9754-2007 |
| Solid content | ≥43% | | GB/T 1725-2007 |
| Impact resistance | 50 | kg · cm | GB/T 1732-93 |
| Hardness | ≥H | | GB/T 6739-2006 |
| Adhesion | Grade 0 | | GB/T 1720-79 |
| Salt spray | 240 | h | GB/T 1771-2007 |

resistance

Thus it can be seen that the water-based two-component polyurethane topcoat in this embodiment has good adhesion, high hardness, good anti-corrosion effect and is safe and environmentally friendly.

The nano-silicon varnish is composed of a high-branched chain ternary polymer, is reformed into an inorganic surface with hardness ≥4 H, and can form a coating with high hardness on the surface of the object. When the surface of clothes or articles rubbed against the slide surface, the high-hardness surface will avoid wear or scratching. The inorganic siloxane bond (—Si—O—Si—) in polysiloxane has high thermal stability and will not be decomposed or broken due to chemical reaction of the coating under a high temperature environment or heat generated by friction, thereby providing the formed coating with good abrasion resistance and high hardness, and prolonging the service life of ordinary coating. At the same time, it possess super adhesion, dirt resistance, wear resistance, aging resistance, heat resistance, corrosion resistance, chemical resistance, insulation, good hydrophobicity, high hardness and easy application. It is fire resistance, has strong water impact resistance under strong adhesion. It possesses certain flexibility and is non-toxic and pollution-free. It can be directly sprayed on the surface of various metals, non-metallic inorganic materials and some organic materials to form a hard layer similar to a silica ceramic film.

Moreover, the aforementioned water-based two-component polyurethane topcoat and nano-silicon varnish are ten times cheaper than the existing coatings in the market, thereby saving cost.

In this embodiment, the coating method of the composite coating on the slide comprises the following steps:
S1, using a flat coating roller with a bristle length of more than 16 mm to coat the water-based two-component polyurethane topcoat on the surface of the slide after uniformly stirring the water-based two-component polyurethane topcoat, wherein the application viscosity of the water-based two-component polyurethane topcoat is greater than 140 KU;
S2, rolling patterns on the surface of the water-based two-component polyurethane topcoat by using a sponge embossing roller before the surface of the water-based two-component polyurethane topcoat dries, so that the patterns are clearer and more obvious, and rolling the second time 1 hour later;
S3, after rolling is completed, place to dry for 24 h, then using a short-bristle flat coating roller to roll the nano-silicon varnish after confirming surface of the water-based two-component polyurethane topcoat has dried, and rolling one more layer of nano-silicon varnish 30 min later to form a smooth surface.

The thickness and smoothness of the coating do not affect the performance, as long as the coating is applied to the necessary areas. The water-based two-component polyurethane topcoat and the nano-silicon varnish in the coating obtained by the aforementioned application method both have good adhesion ability, the water-based two-component polyurethane topcoat can be well fixed on the fiberglass layer of the slide, and the step of rolling patterns on the surface of the water-based two-component polyurethane topcoat by using the sponge embossing roller before the water-based two-component polyurethane topcoat dries increases the contact area with the nano-silicon varnish, indirectly promotes the adhesion ability of the nano-silicon varnish and assures the firmness of the composite coating. On the basis of not changing the height and external structure of the slide, the safety of the slide is ensured, and the frictional resistance of the surface of the slide is reduced by adding smooth nano-silicon varnish, thereby increasing the entertainment value.

In the coating method of the composite coating on the slide in this embodiment, the application amount of the water-based two-component polyurethane topcoat is 5 kg of water-dispersible polyisocyanate and 0.75 kg of water-based polyurethane paint, and the total application amount is 0.1 kg/m²; and the nano-silicon varnish is applied at 0.1 kg/m² per time. The coating formed is thin, saving cost and having a good effect.

In the coating method of the composite coating on the slide in this embodiment, a lubricant is also coated on the composite coating on the surface of the slide. The lubricant is a commercial lubricant. The lubricant is applied at night so that the surface of the slide absorbs all of the lubricant. The slide can be used 12 hours after application of the lubricant. The lubricant is applied once a week for maintenance to strengthen the lubricating effect of the slide and ensure the entertainment value of the slide.

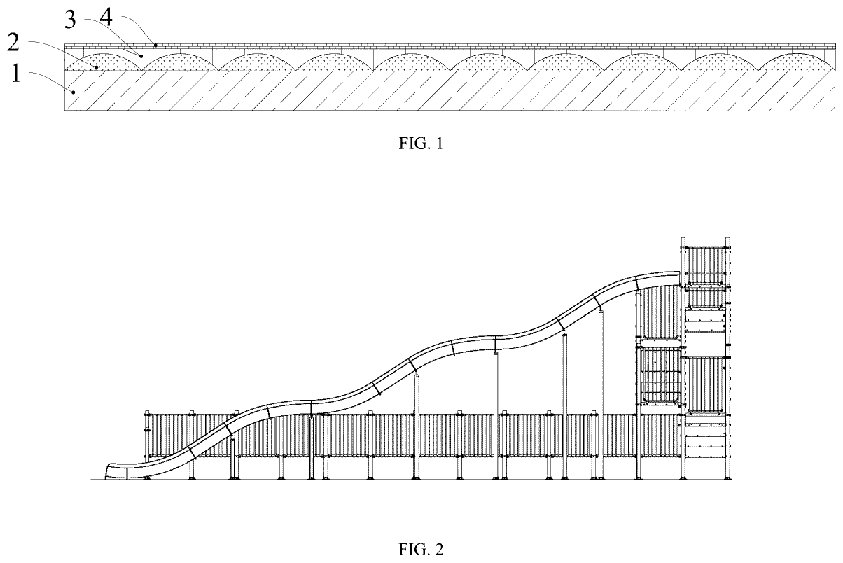

As shown in FIG. 1, an irregular water-based two-component polyurethane topcoat 2 is coated on the fiberglass surface 1 of the slide in this embodiment. A nano-silicon varnish 3 that forms a smooth surface is coated on the water-based two-component polyurethane topcoat 2, and a lubricant 4 is coated on the nano-silicon varnish 3. The obtained slide generates small frictional resistance and has high entertainment value.

As shown in FIG. 2, the slide 5 in this embodiment can be used by directly sliding down from the surface of the slide or be used together with a nylon pad. The nylon pad is placed on the surface of the slide 5, and the person or object is located on the nylon pad and slides down from the slide surface together with the nylon pad; and the density of the bottom surface of the nylon pad is 18 to 60 mesh.

Tests were done by using a TMY ceramic tile friction coefficient tester (L1105) at ambient temperature of 21° C.˜25° C. and relative humidity of 45%˜55% according to GB/T 22374-2018. According to the results, the dry friction coefficient was 0.11 when the friction block wrapped with 60-mesh nylon fabric, while the dry friction coefficient was 0.55 when the standard method was used without using nylon fabric, indicating that the slide used together with a nylon pad can significantly reduce frictional resistance and further avoid the problem of deceleration of people or objects on the slide, thereby increasing the entertainment value of the slide. The use of nylon pads of different densities can achieve different degrees of anti-friction effects, thereby achieving different sliding speeds.

The above embodiment is only a preferred embodiment of the present invention and is not intended to limit the implementation scope of the present invention, so all equivalent changes or modifications made in accordance with the structure, features and principle of the present invention shall be included in the scope of application for the present invention.

1. A coating method of a composite coating on a slide, wherein the composite coating comprises a water-based two-component polyurethane topcoat and a nano-silicon varnish;

the coating method of the composite coating on the slide comprising the following steps:
S1, uniformly stirring the water-based two-component polyurethane topcoat and then coating the surface of the slide with the water-based two-component polyurethane topcoat;
S2, rolling patterns on the surface of the water-based two-component polyurethane topcoat by using a sponge embossing roller before the surface of the water-based two-component polyurethane topcoat dries; and
S3, after rolling is completed, place to dry, and then coat the nano-silicon varnish to form a smooth surface after confirming the surface of the water-based two-component polyurethane topcoat has dried.

2. The coating method of the composite coating on the slide according to claim 1, wherein:
in S2, the water-based two-component polyurethane topcoat is rolled at least twice; and
in S3, the nano-silicon varnish being coated at least twice.

3. The coating method of the composite coating on the slide according to claim 1, wherein:
the coating method in S1 and S3 is roll coating or spray coating.

4. The coating method of the composite coating on the slide according to claim 3, wherein:
the coating method in S1 comprises: using a flat coating roller with a bristle length of more than 16 mm to coat the water-based two-component polyurethane topcoat on the surface of the slide after uniformly stirring the water-based two-component polyurethane topcoat.

5. The coating method of the composite coating on the slide according to claim 1, wherein:
the water-based two-component polyurethane topcoat comprises water-dispersible polyisocyanate and water-based polyurethane paint, the water-based polyurethane paint comprising water-based polyurethane emulsion, polyether-modified siloxane leveling agent, defoaming agent, thixotropic anti-sagging additive, wetting leveling agent, wetting agent, PH regulator, preservative, deionized water and thickening agent, and the mass ratio between the water-dispersible polyisocyanate and the water-based polyurethane paint being 10:1˜2:1; and
the nano-silicon varnish comprising polysiloxane resin, polyether-modified siloxane leveling agent, organic silicone defoaming agent and solvent.

6. The coating method of the composite coating on the slide according to claim 5, wherein:
the application viscosity of the water-based two-component polyurethane topcoat is greater than 140 KU.

7. The coating method of the composite coating on the slide according to claim 5, wherein:
the total application amount of the water-based two-component polyurethane topcoat is 0.1 kg/m²;
and the nano-silicon varnish is applied at 0.1 kg/m² per time.
8. A slide, wherein: the slide is obtained by coating the composite coating using the coating method of the composite coating on the slide according to any of claims 1 to 7.

9. The slide according to claim 8, wherein:
a lubricant is coated on the composite coating on the surface of the slide.

10. A slide use method, wherein:
the slide is a slide according to claim 8 or 9;
the slide being used together with a nylon pad, and a person or an object being located on the nylon pad and sliding down from the slide surface together with the nylon pad; and
the density of the nylon pad being 18 to 60 mesh.

1. A coating method of a composite coating on a slide, wherein the composite coating comprises a water-based two-component polyurethane topcoat and a nano-silicon varnish;
the coating method of the composite coating on the slide comprising the following steps:
S1, uniformly stirring the water-based two-component polyurethane topcoat and then coating the surface of the slide with the water-based two-component polyurethane topcoat;
S2, rolling patterns on the surface of the water-based two-component polyurethane topcoat by using a sponge embossing roller before the surface of the water-based two-component polyurethane topcoat dries; and
S3, after rolling is completed, place to dry, and then coat the nano-silicon varnish to form a smooth surface after confirming the surface of the water-based two-component polyurethane topcoat has dried.

2. The coating method of the composite coating on the slide according to claim 1, wherein:
in S2, the water-based two-component polyurethane topcoat is rolled at least twice; and
in S3, the nano-silicon varnish being coated at least twice.

3. The coating method of the composite coating on the slide according to claim 1, wherein:
the coating method in S1 and S3 is roll coating or spray coating.

4. The coating method of the composite coating on the slide according to claim 3, wherein:
the coating method in S1 comprises: using a flat coating roller with a bristle length of more than 16 mm to coat the water-based two-component polyurethane topcoat on the surface of the slide after uniformly stirring the water-based two-component polyurethane topcoat.

5. The coating method of the composite coating on the slide according to claim 1, wherein:
the water-based two-component polyurethane topcoat comprises water-dispersible polyisocyanate and water-based polyurethane paint, the water-based polyurethane paint comprising water-based polyurethane emulsion, polyether-modified siloxane leveling agent, defoaming agent, thixotropic anti-sagging additive, wetting leveling agent, wetting agent, PH regulator, preservative, deionized water and thickening agent, and the mass ratio between the water-dispersible polyisocyanate and the water-based polyurethane paint being 10:1˜2:1; and
the nano-silicon varnish comprising polysiloxane resin, polyether-modified siloxane leveling agent, organic silicone defoaming agent and solvent.

6. The coating method of the composite coating on the slide according to claim 5, wherein:
the application viscosity of the water-based two-component polyurethane topcoat is greater than 140 KU.

7. The coating method of the composite coating on the slide according to claim 5, wherein:
the total application amount of the water-based two-component polyurethane topcoat is 0.1 kg/m²;
and the nano-silicon varnish is applied at 0.1 kg/m² per time.

8. A slide, wherein: the slide is obtained by coating the composite coating using the coating method of the composite coating on the slide according to claim 1.

9. The slide according to claim 8, wherein:
a lubricant is coated on the composite coating on the surface of the slide.

10. A slide use method, wherein:
the slide is a slide according to claim 8;
the slide being used together with a nylon pad, and a person or an object being located on the nylon pad and sliding down from the slide surface together with the nylon pad; and
the density of the nylon pad being 18 to 60 mesh.
